(19) United States
(12) Patent Application Publication
(10) Pub. No.: US 2021/0197790 A1
(43) Pub. Date: Jul. 1, 2021

(54) AIR CASTER WITH SKIRT STABILIZER

(71) Applicant: Thomas Driscoll, Red Deer (CA)

(72) Inventor: Thomas Driscoll, Red Deer (CA)

(21) Appl. No.: 17/138,972

(22) Filed: Dec. 31, 2020

Related U.S. Application Data
(60) Provisional application No. 62/956,057, filed on Dec. 31, 2019.

(51) Int. Cl. B60V 1/16; B60V 1/04

(52) U.S. Cl. CPC B60V 1/16; B60V 1/043

(57) ABSTRACT

In one aspect there is provided an air caster comprising a platform to support a load above a surface, a skirt, wherein said skirt cooperates with said platform to define an interior volume, at least one air inlet to allow air to enter said interior volume, at least one air exit to allow air to exit said interior volume, and a skirt stabilizer operable to create a substantially airtight seal between the skirt and the surface, said airtight seal being formed circumferentially around said at least one air exit when the air caster is in a resting state.

### CROSS REFERENCE TO RELATED APPLICATION

This application is a non-provisional application which claims priority to, and benefit of, U.S. Provisional Patent Application Ser. No. 62/956,057 filed Dec. 31, 2019 and entitled, “AIR CASTER WITH SKIRT STABILIZER”, the entirety of which is incorporated herein by reference.

### FIELD OF THE INVENTION

This invention relates generally to air casters. More particularly, the invention relates to an air caster with means for securing or stabilizing the skirt or diaphragm.

### BACKGROUND OF THE INVENTION

The background information discussed below is presented to better illustrate the novelty and usefulness of the present invention. This background information is not admitted prior art.

An air caster is a pneumatic lifting device used to move heavy loads on substantially flat and non-porous surfaces. Similar to a hovercraft, an air caster uses a thin layer of air to float a support platform a very small distance off the ground, generally in a frictionless relation. Compressed air enters an airbag positioned underneath the support platform. The airbag is typically shaped like a torus or hem i-torus. When the airbag is filled it creates an airtight seal with the ground. Any excess air is moved to the center of torus (via an outlet or opening), eventually causing the air to flow out the bag and raising the air caster and any load a small distance above the ground. The airbag may comprise a flexible membrane, diaphragm, skirt or the like.

One type of air caster (or air bearing) is disclosed in Snoeyenbos U.S. Pat. No. 3,246,711. There the skirt is an annular single convolution flexible membrane or diaphragm having its outer periphery connected in sealed relation with the outer perimeter of the air caster's platform, and its inner periphery sealingly connected centrally beneath platform in generally concentric relation with a central opening formed in the latter.

Air casters may also be constructed by do-it-yourselfers and hobbyists from simple materials, such as plywood for the platform and plastic sheeting (e.g. polyethylene) to construct the airbag or skirt.

One problem with conventional air casters is that the skirt may fold or ripple when the source of compressed air is turned off. Then, when the compressed air is turned on again, those ripples or folds may prevent a proper seal from forming between the air bag and the surface upon which the aircaster is situated. If that happens, compressed air will simply continue to escape out from underneath the air caster, and prevent sufficient air pressure from building up inside the airbag, and the air caster will not lift off of the surface.

Therefore, what is needed is an apparatus or system that prevents the airbag's flexible membrane from folding or rippling (when the compressed air is turned off), and which can also be easily utilized by do-it-yourselfers and hobbyists.

### SUMMARY OF THE INVENTION

In an embodiment of the invention there is provided an air caster comprising a platform to support a load above a surface, a skirt, wherein said skirt cooperates with said platform to define an interior volume, at least one air inlet to allow air to enter said interior volume, at least one air exit to allow air to exit said interior volume, and a skirt stabilizer operable to create a substantially airtight seal between the skirt and the surface, said airtight seal being formed circumferentially around said at least one air exit when the air caster is in a resting state.

In another embodiment of the invention there is provided an aircaster comprising a platform to support a load above a surface, the platform having a platform outer periphery, a skirt, wherein said skirt cooperates with said platform to define an interior volume, at least one air inlet to allow air to enter said interior volume, at least one air exit to allow air to exit said interior volume, and a skirt stabilizer of sufficient weight and dimensions to maintain tension on at least one section of the skirt that is between the platform outer periphery and the skirt stabilizer.

### BRIEF DESCRIPTION OF THE DRAWINGS

Referring to the drawings, several aspects of the present invention are illustrated by way of example, and not by way of limitation, in detail in the figures, wherein:

FIG. 1 is a perspective view of one embodiment of an air caster with skirt stabilizer of the present invention, shown in a resting state resting on the floor;

FIG. 2 is a side perspective view of the air caster with skirt stabilizer of FIG. 1, shown in a lifting state and being lifted a small distance above the floor and with compressed air flowing out from underneath the air caster;

FIG. 3 is another a perspective view of the air caster with skirt stabilizer of FIG. 1, shown in the lifted state, with compressed air flowing out from underneath the air caster, and with the air adjuster partially open;

FIG. 4 is a side, bottom perspective view of the air caster with skirt stabilizer of FIG. 1, shown with the skirt stabilizer tensioning the skirt;

FIG. 5 is a close-up perspective view of the skirt stabilizer of the embodiment of FIG. 1;

FIG. 6a is a sectioned view of the air caster with skirt stabilizer of FIG. 1, taken along lines 6-6 in FIG. 1 and shown in the resting state;

FIG. 6b is a sectioned view of the air caster with skirt stabilizer of FIG. 1, taken along lines 6-6 in FIG. 1 and shown in the lifting state;

FIG. 7a is a sectioned view of the air caster with skirt stabilizer of FIG. 1, taken along lines 7-7 in FIG. 1 and shown in the resting state;

FIG. 7b is a sectioned view of the air caster with skirt stabilizer of FIG. 1, taken along lines 7-7 in FIG. 1 and shown in the lifting state;

FIG. 8 is a bottom perspective view of another embodiment of an air caster with skirt stabilizer of the present invention, illustrating a plurality of openings in the skirt;

FIGS. 9a-9b are perspective views of yet another embodiment of an air caster with skirt stabilizer of the present invention, shown in the resting state;

FIGS. 10a-10b are perspective views of the embodiment of an air caster with skirt stabilizer of FIG. 9a, shown in the lifting state;

FIGS. 11a and 11b are a sectioned view of the air caster with skirt stabilizer of FIG. 9a, shown in the resting state and lifting state respectively; and

FIGS. 12a and 12b are another sectioned view of the air caster with skirt stabilizer of FIG. 9a, shown in the resting state and lifting state respectively.

### DETAILED DESCRIPTION OF THE PREFERRED EMBODIMENTS

The following description is of preferred embodiments by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

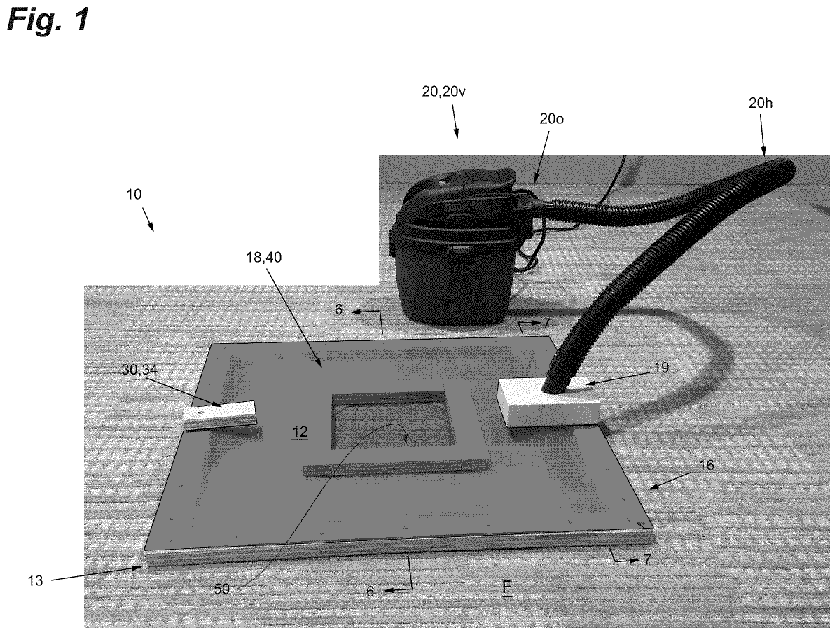

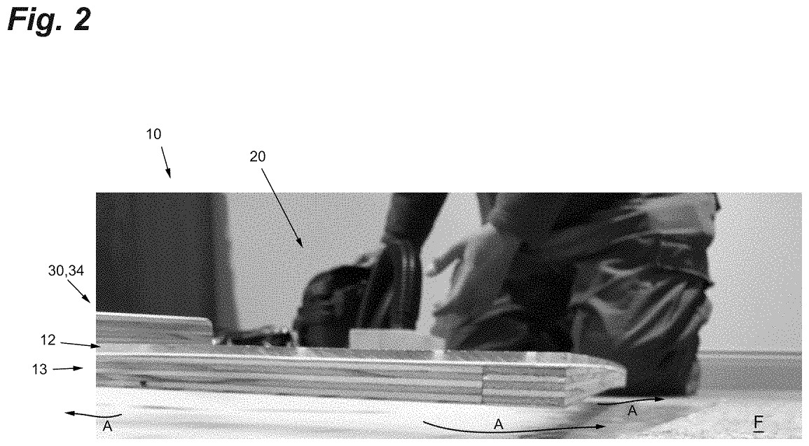

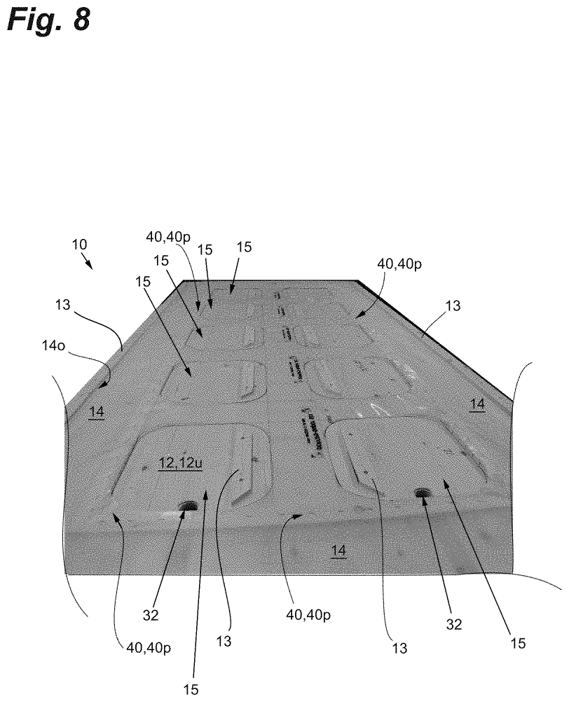

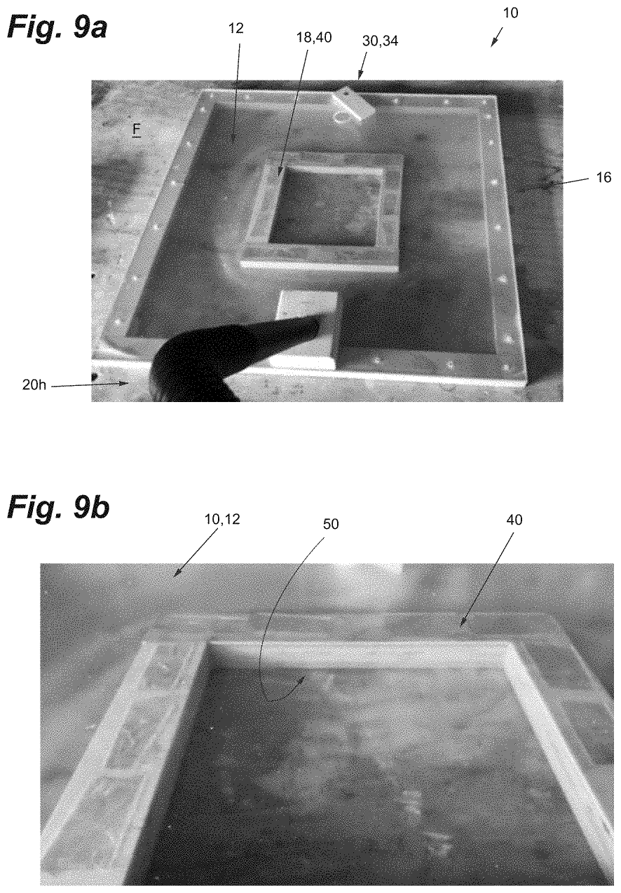

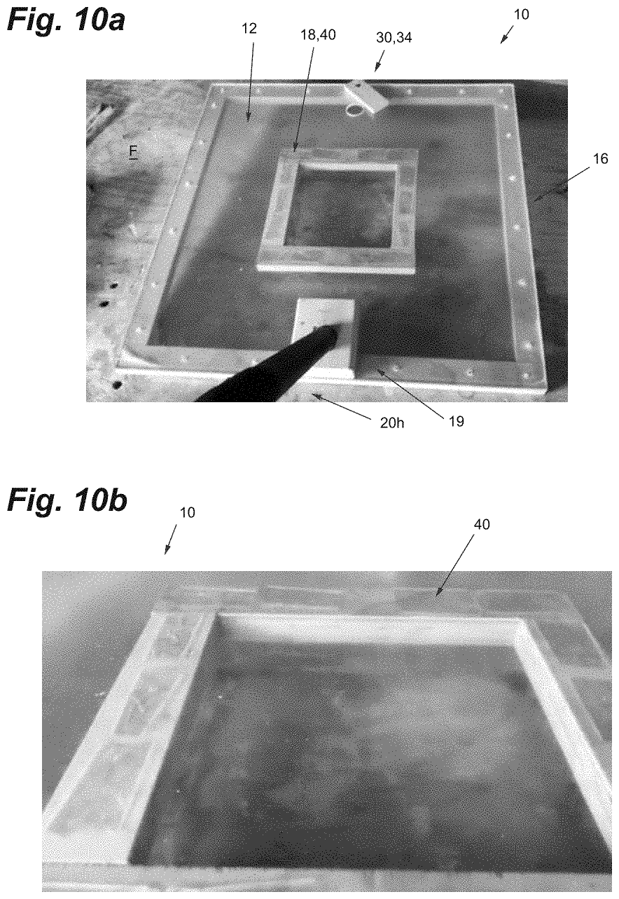

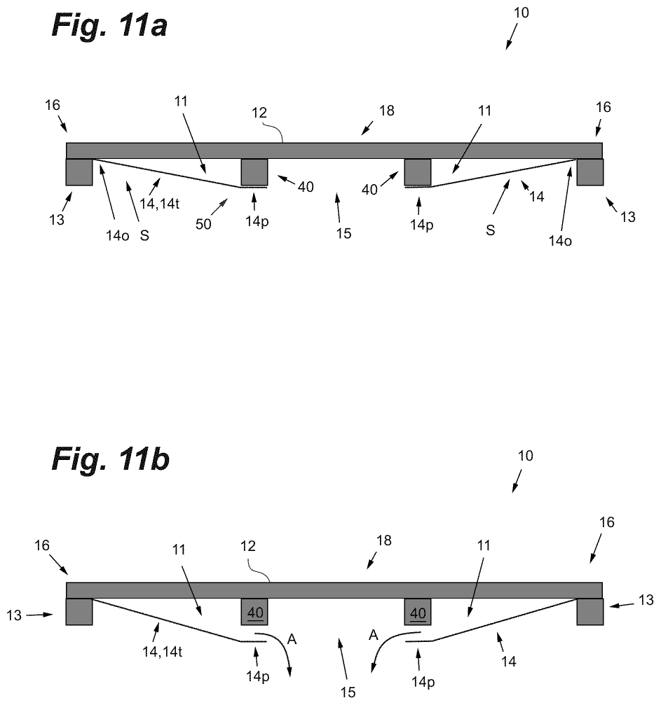

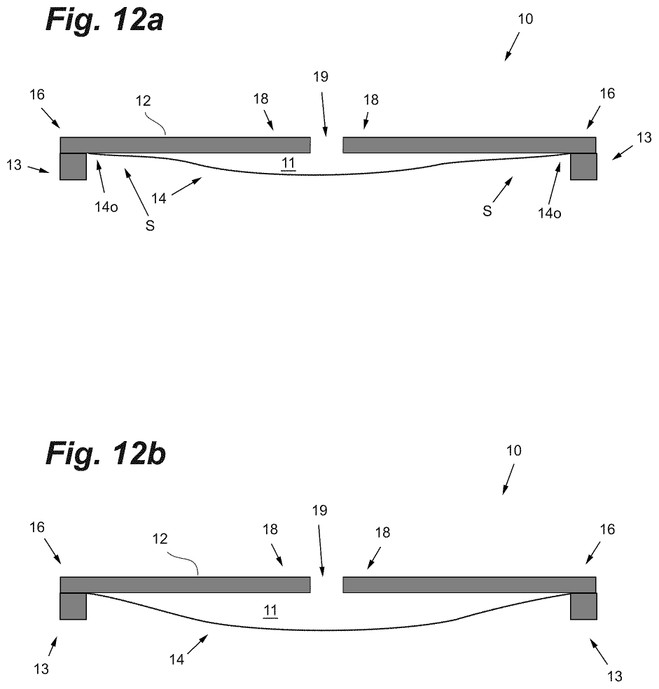

A first embodiment of the air caster 10 with skirt stabilizer 40 of the present invention is shown in FIGS. 1-7b. Another embodiment of the air caster 10 with skirt stabilizer 40 is shown in FIG. 8. Yet another embodiment of the air caster 10 with skirt stabilizer 40 is shown in FIGS. 9a-12b.

The air caster 10 comprises a substantially rigid platform 12 upon which a load (not shown) can be placed, and a flexible membrane, diaphragm, skirt or airbag 14 (hereinafter simply referred to as skirt 14) to contain compressed air A within an interior volume 11 in a conventional manner. The skirt 14 may form a hemi-torus or other conventional shape when filled with compressed air. Compressed air A can be provided to the air caster 10 via a source of compressed air 20, such as from the outlet 20o of a vacuum cleaner 20v via a hose 20h. Compressed air A is preferably directed into the interior volume 11 of the skirt 14 via at least one air inlet or opening 19 in the platform 12. Preferably, if a hose 20h is used to direct the compressed air A, the hose 20h is sealably connected to opening 19 via a variety of conventional methods, including via frictional engagement in opening 19 (as shown in FIG. 1).

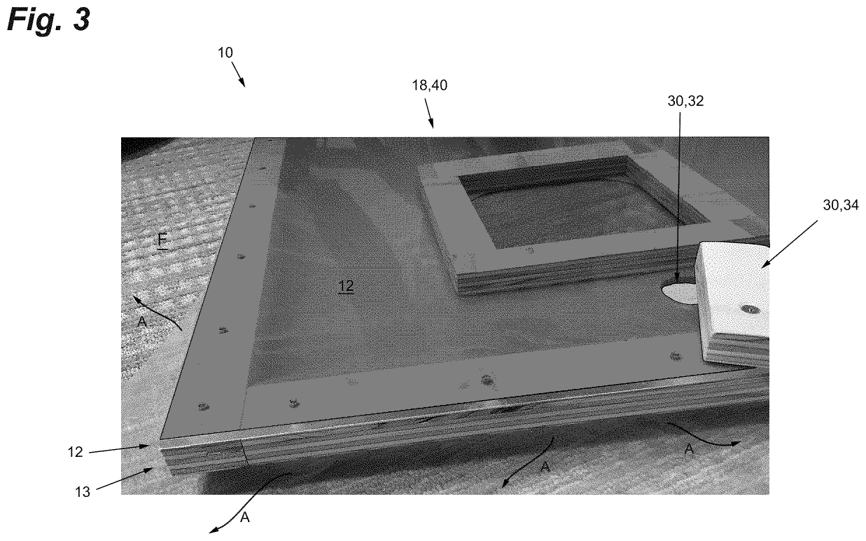

The substantially rigid platform 12 may be made of any suitable material of sufficient strength and durability to support a load (not shown) thereupon; for example, the platform 12 may be made of steel, wood, plywood, plastic or plexiglass. In the embodiment of FIGS. 1-7b, the platform 12 is a substantially planar member, having a comprised of a semi-transparent acrylic glass (e.g. PLEXIGLAS™), which allows for easier visualization of the skirt stabilizer 40 when the air caster 10 is viewed from above (see FIGS. 1 and 3). The skirt 14 may be made of any suitable material of sufficient strength and durability to contain the compressed air A (within the interior volume 11) and to withstand repeated filling and emptying of the interior volume 11 with compressed air A. In the embodiment of FIGS. 1-7b, the skirt 14 is comprised of plastic sheeting, such as polyethylene sheeting.

The platform 12 preferably further comprises an outer periphery 16 and an inner periphery 18. Preferably the inner periphery 18 is centrally, or substantially centrally, located on the platform 12. More preferably the skirt 14 has its outer periphery 14o sealably attached to the underside of the platform 12 along all, or substantially all, of the platform's outer periphery 16; and the skirt 14 ends or terminates at the skirt's inner periphery 14p forming at least one air exit aperture or opening 15 (as illustrated in the Figures). Attachment of the skirt's outer periphery 14o to the platform's outer periphery 16 may be accomplished by using conventional attachment and sealing means, such as stapling or gluing. One or more platform supports 13 may be provided to support or lift the platform 12 some distance (e.g. 1 inch) above a surface such as the ground or floor F when the air caster is in a resting state and the source of compressed air A is shut off (e.g. see FIG. 1). Platform supports 13 may be a plurality of legs or support members; or, as shown in the embodiment of FIGS. 1-7b, platform support 13 may also be a circumferential ridge that is mounted to the underside of the platform 12 along all, or substantially all, of the platform's outer periphery 16 (as illustrated in the Figures). In the embodiment of FIGS. 1-7b, platform support 13 is made from plywood, but any other suitable rigid and supporting material will suffice.

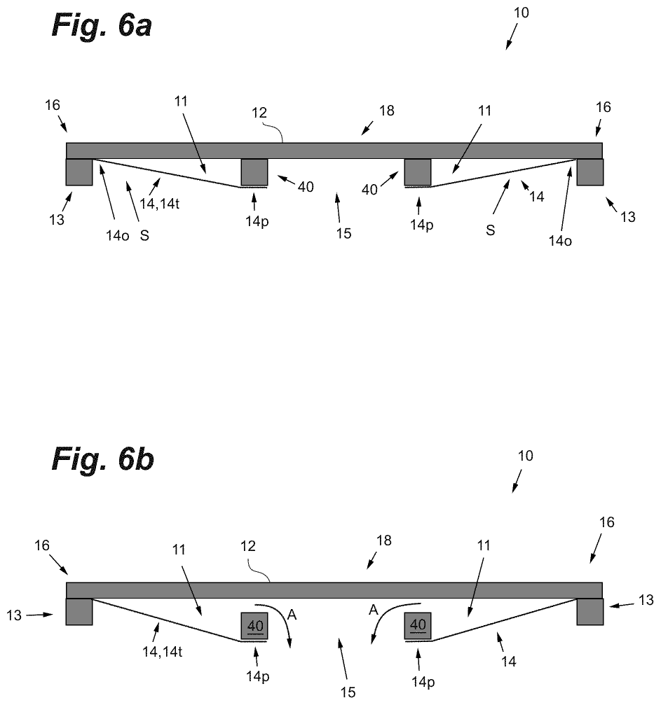

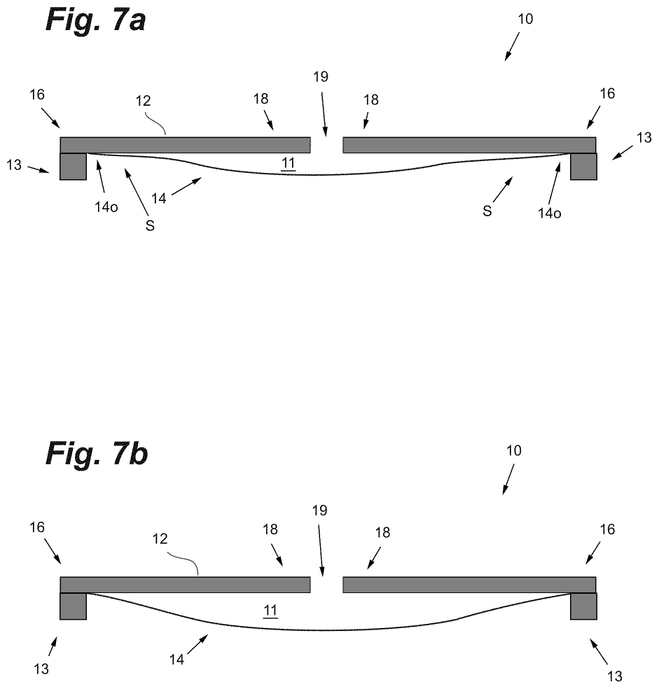

Preferably, the skirt's outer periphery 14o is sealably attached to the underside 12u of the platform 12 along all, or substantially all, of the platform's outer periphery 16, thereby creating the interior volume 11 between the underside 12u of the platform and the skirt 14. More preferably, the skirt's outer periphery 14o is also sandwiched between the underside 12u of the platform 12 and the platform support 13 (e.g. see FIGS. 6a-7b). Advantageously, a substantially circumferential platform support 13 along the outer periphery 16 assists in maintaining the sealed connection of the skirt's outer periphery 14o to the underside of the platform, supporting the platform 12 and any load on the air caster 10 when in the resting state, and providing some clearance or space S for the skirt 14 to stretch out (and unripple) when in the resting state (see FIGS. 6a and 7a).

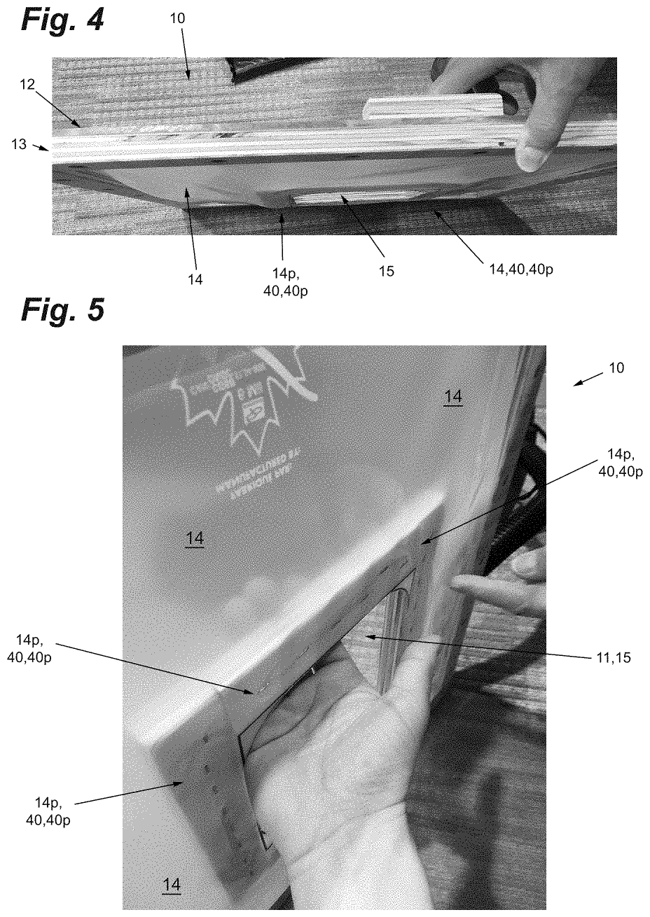

To allow compressed air A to escape or exit out of the interior volume 11, the skirt 14 is provided with the at least one air exit aperture or opening 15. Preferably, the at least one aperture or opening 15 is centrally located within the skirt 14, substantially beneath the platform's inner periphery 18 (see FIGS. 4, 6a-6b).

More preferably, one or more air adjusters 30 are provided which may comprise an opening 32 in the platform 12 and an adjustable cover 34 to selectively cover and uncover the opening 32, to provide one or more alternate exits for compressed air A to escape out of the interior volume 11. Advantageously, the air adjuster 30 can be selectively engaged by a user of the air caster 10 to adjust how much compressed air A is maintained within the interior volume 11. The air adjuster 30 can also assist in releasing air A from the interior volume 11 when it is desired to put the air caster 10 in the resting state.

A skirt stabilizer 40 is preferably mounted on the skirt 14, within the interior volume 11 (between the skirt 14 and bottom of the platform 12). The skirt stabilizer 40 is preferably positioned circumferentially around all of the apertures or openings 15 thereby forming a skirt stabilizer perimeter 40p (e.g. see the embodiment of FIG. 8). In the embodiment of FIG. 1 the skirt stabilizer 40 is mounted to the skirt 14 (not to the platform 12) and can therefore move with the skirt 14, as the skirt 14 expands or stretches in response to compressed air A, when the air caster 10 goes from a resting state (e.g. FIG. 6a) to a lifting state (6b). In the embodiment of FIG. 9a the skirt stabilizer 40 is mounted to the underside of the platform 12 in a predetermined position above, and around, all of the apertures or openings 15 so as to form a skirt stabilizer perimeter 40p when in the resting state.

Preferably, during operation of the air caster when a source of compressed air A is provided to the interior volume 11 (e.g. via air inlet 19), the skirt stabilizer 40 will substantially sealably engage, or push, a portion of the skirt 14 to floor F, thereby forming said skirt stabilizer perimeter 40p around all of the one or more openings 15.

More preferably, the skirt stabilizer 40 is of sufficient weight and dimensions (and/or is mounted to the interior of the skirt 14 as in the embodiment of FIG. 1) to maintain tension on a section 14t of the skirt 14 that is between the outer periphery 16 and the skirt stabilizer 40. Advantageously, by providing the tensioned section 14t, the skirt stabilizer 40 reduces or eliminates the skirt 14 from folding or rippling, including when the compressed air is turned off.

Even more preferably, the skirt stabilizer 40 and the platform supports 13 are of substantially the same height, so that they cooperate together to support the platform 12 (and any load thereon) when the air caster 10 is in the resting state.

When in the resting state, the skirt stabilizer's perimeter 40p preferably creates an airtight, or substantially airtight, seal 50 with the ground or floor F (around the skirt's inner perimeter 14p and around the at least one air exit aperture 15) until sufficient air pressure builds up in the interior volume, after which any excess air A then flows out the interior volume 11 (via the at least one aperture 15) and raises the air caster 11 and any load a small distance above the ground or floor F. More advantageously, by creating the seal 50 with the ground or floor F during the resting state, air pressure can quickly and easily build up inside the interior volume 11 to a level that is then sufficient to move the air caster 10 to a lifting state. Even more advantageously, the seal 50 will assist in reducing or eliminating the skirt 14 from folding or rippling, including when the compressed air is turned off.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

1. An air caster comprising:
a platform to support a load above a surface;
a skirt, wherein said skirt cooperates with said platform to define an interior volume;
at least one air inlet to allow air to enter said interior volume;
at least one air exit to allow air to exit said interior volume; and
a skirt stabilizer operable to create a substantially airtight seal between the skirt and the surface, said airtight seal being formed circumferentially around said at least one air exit when the air caster is in a resting state.

2. The air caster of claim 1 wherein the skirt stabilizer is mounted to the skirt within the interior volume.

3. The air caster of claim 1 wherein the skirt stabilizer is mounted within the interior volume, between the skirt and the platform.

4. The air caster of claim 1 wherein the air caster further comprises a platform support.

5. The air caster of claim 4 wherein the platform further comprises an underside and a platform outer periphery; and
wherein the platform support is a circumferential ridge that is mounted to the underside of the platform along substantially all of the platform outer periphery.

6. The air caster of claim 4 wherein the skirt stabilizer and the platform support are substantially the same height.

7. The air caster of claim 5 wherein the skirt further comprises a skirt outer periphery;
wherein the skirt outer periphery is sealably attached to the underside of the platform along substantially all of the platform outer periphery; and
wherein the skirt outer periphery is positioned between said underside of the platform and said circumferential ridge.

8. The air caster of claim 1 wherein the platform further comprises an underside and a platform outer periphery;
wherein the skirt further comprises a skirt outer periphery; and
wherein the skirt outer periphery is sealably attached to the underside of the platform along substantially all of the platform outer periphery.

9. An air caster comprising:
a platform to support a load above a surface, the platform having a platform outer periphery;
a skirt, wherein said skirt cooperates with said platform to define an interior volume;
at least one air inlet to allow air to enter said interior volume;
at least one air exit to allow air to exit said interior volume; and
a skirt stabilizer of sufficient weight and dimensions to maintain tension on at least one section of the skirt that is between the platform outer periphery and the skirt stabilizer.

10. The air caster of claim 9 wherein the skirt stabilizer is mounted to the skirt within the interior volume.

11. The air caster of claim 9 wherein the skirt stabilizer is mounted within the interior volume, between the skirt and the platform.

12. The air caster of claim 9 wherein the air caster further comprises a platform support.

13. The air caster of claim 12 wherein the platform further comprises an underside; and
wherein the platform support is a circumferential ridge that is mounted to the underside of the platform along substantially all of the platform outer periphery.

14. The air caster of claim 12 wherein the skirt stabilizer and the platform support are substantially the same height.

15. The air caster of claim 13 wherein the skirt further comprises a skirt outer periphery;
wherein the skirt outer periphery is sealably attached to the underside of the platform along substantially all of the platform outer periphery; and
wherein the skirt outer periphery is positioned between said underside of the platform and said circumferential ridge.

16. The air caster of claim 9 wherein the platform further comprises an underside;
wherein the skirt further comprises a skirt outer periphery; and
wherein the skirt outer periphery is sealably attached to the underside of the platform along substantially all of the platform outer periphery.
